(19) United States
(12) Patent Application Publication
(10) Pub. No.: US 2024/0096068 A1
(43) Pub. Date: Mar. 21, 2024

(54) AUTO-GROUPING GALLERY WITH IMAGE SUBJECT CLASSIFICATION

(71) Applicant: International Business Machines Corporation, Armonk, NY (US)

(72) Inventors: Ying Li, Shanghai (CN); Fang Lu, Shanghai (CN); Yuan Yuan Gong, Shanghai (CN); Wen Ting Li, Shanghai (CN); Shi Hui Gui, Shanghai (CN); Xiao Feng Ji, Shanghai (CN)

(21) Appl. No.: 17/949,527

(22) Filed: Sep. 21, 2022

(51) Int. Cl. G06V 10/774; G06V 10/10; G06V 10/26; G06V 10/764; G06V 20/70

(52) U.S. Cl. CPC G06V 10/774; G06V 10/16; G06V 10/26; G06V 10/764; G06V 20/70

(57) ABSTRACT

At least one computer processor can replace visual words of an unsupervised machine learning classification model with visual objects of an image. At least two co-occurring single visual objects adjacent to each other in pixels of the image can be combined to obtain a compound visual object. The unsupervised machine learning classification model can be augmented to model the image as a mixture of subjects, where each subject is represented through placements of the visual objects in a mixture of concentric spheres centering on a mixture of intersections on a mixture of horizontal layers. At least one processor can learn latent relationships between the placements of the visual objects in a three-dimensional space depicted in the image and image semantics. Learning the latent relationships trains the unsupervised machine learning classification model to perform image subject classification through the placements of the visual objects in a new image.

### BACKGROUND

The present application relates generally to computers and computer applications, and more particularly to machine learning, image processing and image classification, and improving existing image classification machine learning.

Organizing and classifying massive images or photos in data stores or galleries can be inefficient and time-consuming. While some automatic image classification methods can help classifying images according to time, locations, scenes, sources etc., there is still a lack of a better automatic classification method for image subjects, a kind of high-level image semantics.

### BRIEF SUMMARY

The summary of the disclosure is given to aid understanding of a computer system and method of image processing and classification, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In an aspect, a computer-implemented method can be provided, which can include replacing visual words of an unsupervised machine learning classification model with visual objects of an image. The method can also include combining at least two co-occurring single visual objects adjacent to each other, based on threshold adjacency, in pixels of the image to obtain a compound visual object. The method can further include augmenting the unsupervised machine learning classification model to model the image as a mixture of subjects, where each subject is represented through placements of the visual objects in a mixture of concentric spheres centering on a mixture of intersections on a mixture of horizontal layers. The method can also include learning latent relationships between the placements of the visual objects in a three-dimensional space depicted in the image and image semantics. The learning can train the unsupervised machine learning classification model to perform image subject classification through the placements of the visual objects in a new image.

In another aspect, a system can be provided, which can include at least one processor. The system can also include a memory device coupled with the at least one processor. The at least one processor can be configured at least to replace visual words of an unsupervised machine learning classification model with visual objects of an image. The at least one processor can also be configured to combine at least two co-occurring single visual objects adjacent to each other, based on threshold adjacency, in pixels of the image to obtain a compound visual object. The at least one processor can also be configured to augment the unsupervised machine learning classification model to model the image as a mixture of subjects, where each subject is represented through placements of the visual objects in a mixture of concentric spheres centering on a mixture of intersections on a mixture of horizontal layers. The at least one processor can also be configured to learn latent relationships between the placements of the visual objects in a three-dimensional space depicted in the image and image semantics. Learning the latent relationships can train the unsupervised machine learning classification model to perform image subject classification through the placements of the visual objects in a new image.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates a schematic of an example computer or processing system that may implement a system that automatically groups a gallery based on augmented Latent Dirichlet Allocation (LDA) according to one embodiment.

FIG. 2 is a method of improving a machine learning model for image subject classification in an embodiment.

FIG. 3A shows examples of some visual words associated with an image.

FIG. 3B shows an example of a visual object associated with an image.

FIG. 4 shows an example of visual objects occurring together in an image.

FIGS. 5A and 5B illustrate examples of spatial relationships in visual objects in images.

FIG. 6 shows an example of a three-dimensional container for visual objects of an image in an embodiment.

FIG. 7 illustrates a generative process in an embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as automatic grouping gallery based on augmented Latent Dirichlet Allocation 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

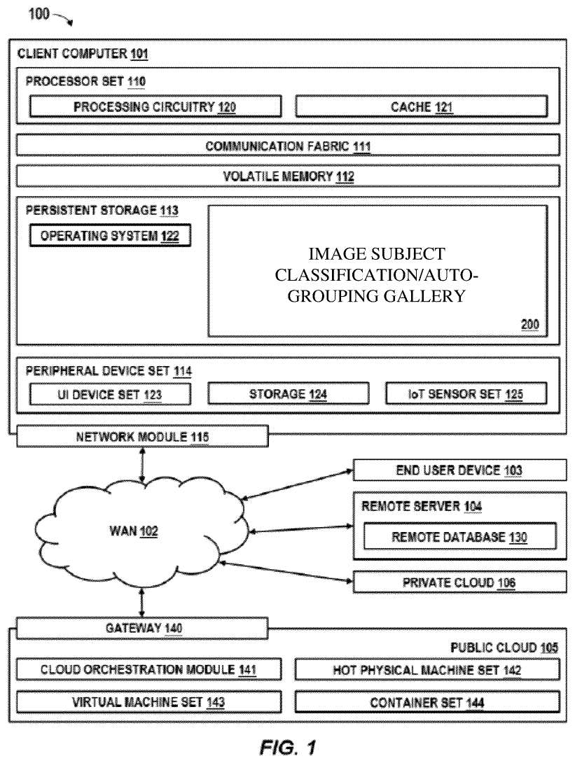

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In various embodiment, systems and methods can provide for image subject classification from the perspective of text, e.g., in images composed of visual elements. In some embodiments, for image subject classification, the systems and methods can provide various improvements to Latent Dirichlet Allocation (LDA), which can discover latent subjects within massive images from the perspective of image based on visual words (low-level image semantics). LDA can be considered as belonging to unsupervised learning in machine learning. The improvements provided in the systems and/or methods in embodiments can enable a smart gallery to automatically group images or photos in a more reasonable and effective way. A gallery refers to a data store or a library of collection of digital images and/or photographs (photos). A smart gallery includes a processing intelligence that can operate with or on such digital images and/or photos.

LDA is a type of unsupervised machine learning, and can discover topics, for example, via topic modeling. LDA can classify data such as images, and can facilitate searching and/or organizing the data.

In an embodiment, the systems and/or methods can implement an LDA model to rely on the distribution of the identified visual objects (e.g., identified through the panoptic or instance segmentation technique), not visual words, for image subject classification. For example, a visual dictionary can be implemented, which can include visual objects depicted in images, which can be identified through the panoptic or instance segmentation techniques. An augmented LDA can generate a probability distribution over single or compound visual objects.

In another embodiment, the systems and/or methods can combine multiple visual objects adjacent to each other in pixels to obtain a compound visual object according to the co-occurrence of single visual objects within a gallery.

Yet in another embodiment, the systems and/or methods can augment an LDA model. For example, regard an image as a three-dimensional container for visual objects, which can include L horizontal layers, S intersections formed by M warp lines and N latitude lines on each layer, where each intersection has Q concentric spheres with different radius levels (e.g., count is Q), centering on that same intersection. L, S, M, N and Q are integer numbers. The systems and/or methods can augment LDA to model an image as a mixture of subjects, where each subject can further be expressed through the placements of visual objects in a mixture of concentric spheres centering on a mixture of intersections on a mixture of horizontal layers. The systems and/or methods can extend the Gibbs Sampling equation to include or support horizontal layer, intersection, and concentric sphere.

In an aspect, a smart gallery can automatically categorize images using a subject model augmented with the three-dimensional space of an image. In an aspect, the systems and/or methods can present the following improvements, which augment the LDA (Latent Dirichlet Allocation) model for improved image subject classification: Replace visual words with visual objects; Combine two or more co-occurrence single visual objects adjacent to each other in pixels to obtain a compound visual object; Augment LDA to model an image as a mixture of subjects, where each subject can further be expressed through the placements of visual objects in a mixture of concentric spheres centering on a mixture of intersections on a mixture of horizontal layers, and then learn the latent relationship between the placements of visual objects in a three-dimensional space depicted in an image and high-level image semantics, and thus, the systems and/or methods can further improve image subject classification through the placements of visual objects in an image; and Extend the Gibbs Sampling equation for the augmented LDA model.

Massive amounts of data such as images can be stored in an organization's local or cloud digital gallery (e.g., a photo album on smart phone). In an embodiment, an automatic grouping of data in a gallery can use image subject classification to allow for organizing and searching such images.

Latent Dirichlet Allocation (LDA), an unsupervised learning and image subject classification, can discover latent subjects within massive images from the perspective of image based on visual words (also referred to as low-level image semantics). The systems and/or methods in some embodiments augment the LDA for classifying images. LDA analyzes visual words (including a part of each visual object). In an embodiment, the systems and/or methods can improve the LDA to include features of each entire visual object in an image, which can further improve the understanding of image subjects (also referred to as high-level image semantics).

In some embodiments, the systems and/or methods can further improve LDA, which is based on bag-of-words model and treats visual words as independent and disordered in an image, by incorporating spatial relationships among visual words in an image, e.g., a two-dimensional image. Such spatial relationships can facilitate expressing and understanding the high-level image semantics.

In some embodiment, the systems and/or methods further improve LDA by incorporating correlations between multiple visual objects in an image, thus further improving the understanding of image semantics.

In some embodiments, the systems and/or methods can implement or generate a smart digital gallery that can automatically classify images based on an augmented image subject classification model, for example, an unsupervised machine learning classification model, for example, built by augmented LDA as described herein.

In some embodiments, the systems and/or methods can provide improvements described herein to an LDA (Latent Dirichlet Allocation) model for image subject classification, enabling a smart gallery to automatically group images or photos in a reasonable and effective way. Such improvements can include replacing visual words with visual objects; combining co-occurring visual objects; and augmenting the LDA model to incorporate spatial relationships.

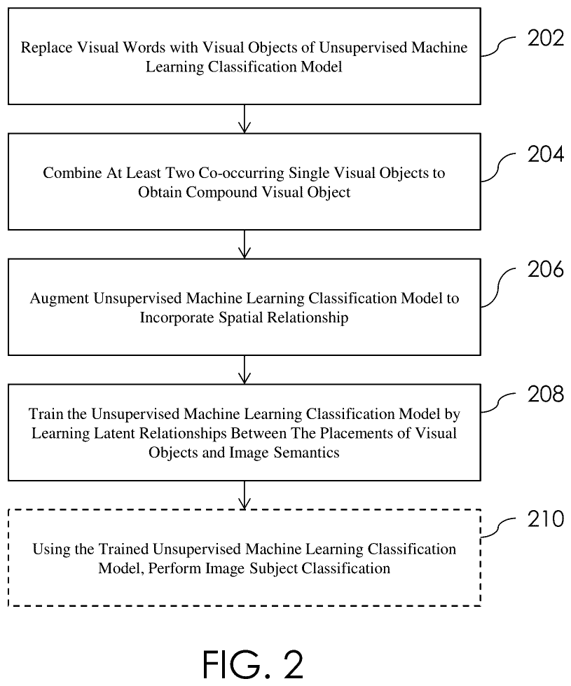

FIG. 2 is a method of improving a machine learning model for image subject classification in an embodiment. The method can be run on or by one or more processors such as those shown in a computing environment of FIG. 1. At 202, at least one processor can replace visual words of an unsupervised machine learning classification model with visual objects of an image. In an embodiment, the unsupervised machine learning classification model can be an LDA model.

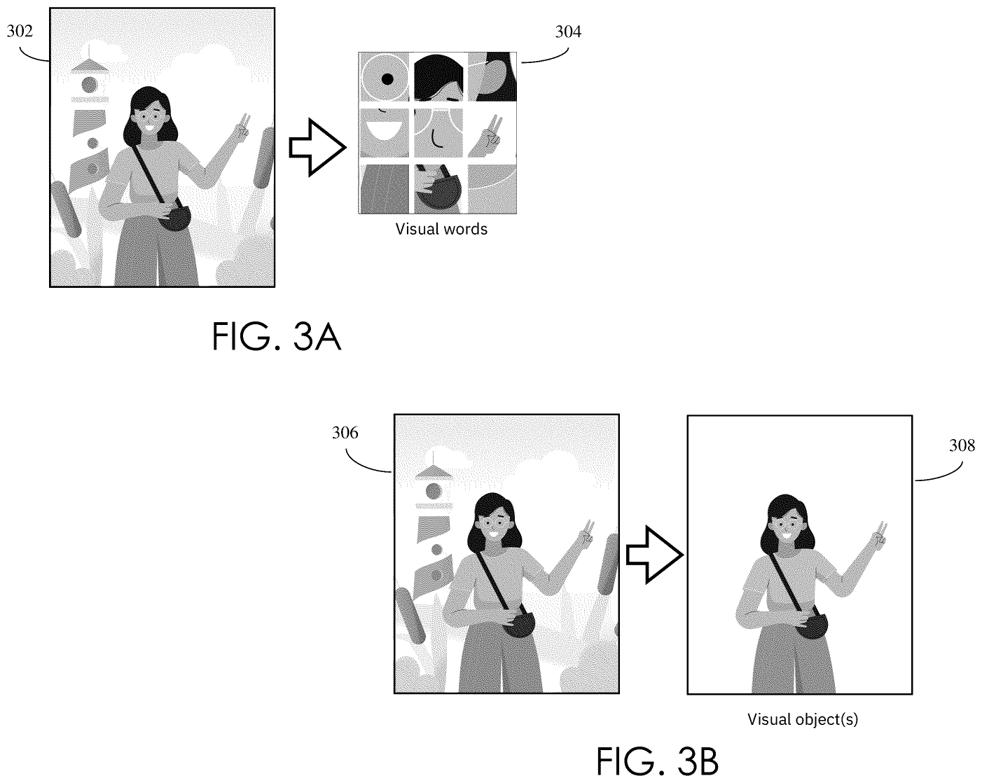

Briefly, existing subject classification technique with LDA may be implemented based on the BoW (Bag of Words) model. Like the use of BoW model in a document, an image is analogous to a document and is composed of visual words, which are converted from the clustered bottom-level features of an image. FIG. 3A shows examples of some visual words 304 associated with an image 302. A visual word, containing bottom-level image features, is a part of a certain complete visual object (here it is a person), and the BoW model assumes that the visual words in an image are disordered or unordered. An existing LDA model relies on the distribution of such visual words rather than visual objects, and does not incorporate the spatial relationship among visual words belonging to same one visual object or the position relationship between a visual word and the visual object to which the visual word belongs. However, when an image is created or picture is taken, complete visual objects are used to compose an image in order to express semantics. Therefore, understanding semantics through visual objects, rather than visual words (containing partial bottom-level image features of visual objects) can improve image subject classification. Hence, in an embodiment, at least one processor identifies complete visual objects in an image through employing one or more of panoptic segmentation, instance segmentation, and/or other image segmentation techniques, and implements the LDA model to rely on the distribution of the identified visual objects, rather than the visual words, for image subject classification. FIG. 3B shows an example of a visual object 308 associated with an image 306.

Image segmentation segments objects in an image. Briefly, instance segmentation distinguishes or treats each instance of object as a single entity, e.g., treats multiple objects of the same class as distinct individual instances. Semantic segmentation identifies classes or categories of objects, e.g., treats multiple objects of the same class as a single entity. Panoptic segmentation treats an object in both category-wise as well as instance-wise manner, e.g., panoptic segmentation assigns two labels (semantic label and instance identifier) to each of the pixels of an image.

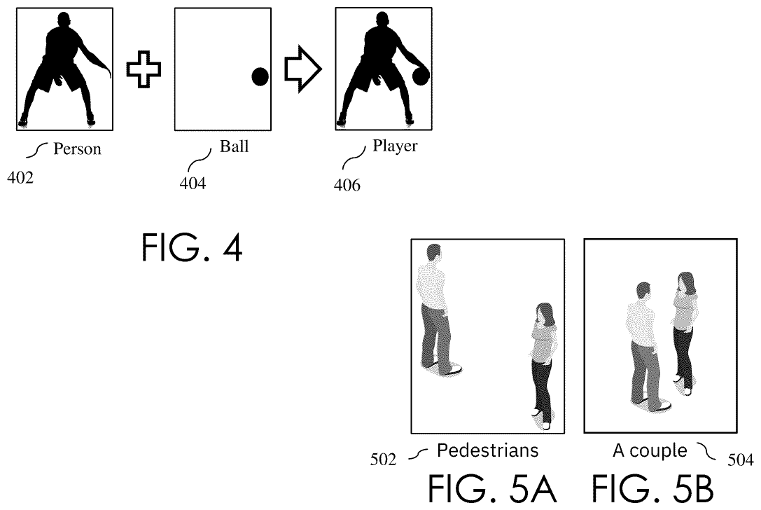

At 204, at least one processor can combine at least two co-occurring single visual objects adjacent to each other, for example, based on threshold adjacency, in pixels of the image to obtain a compound visual object. There is a correlation between visual objects that frequently appear in images at the same time. Although visual objects in an image are treated as irrelevant and disordered according to the BoW model, combining such co-occurrence visual objects together can make the expression and understanding of image semantics more rational and easier. FIG. 4 shows an example of visual objects occurring together in an image. For example, suppose there are two identified visual objects in an image identified through the instance segmentation technique. One object is a ‘man’ 402 and the other is a ‘ball’ 404. Combining these two visual objects can result in a compound visual object ‘player’ 406, and the semantics of the source image is more likely to be related to an athletic activity. FIG. 4 shows an example of visual objects occurring together in an image in an embodiment. In an embodiment, at least one processor combines multiple visual objects adjacent to each other in pixels of an image to obtain a compound visual object according to the co-occurrence of single visual objects within an image or a gallery of images. For example, a gallery includes multiple images.

In an embodiment, compound visual objects can be obtained as follows. For all the single visual objects within a gallery, the co-occurrence matrix of visual objects is X, whose entries Xᵢⱼ tabulate the number of times visual object j occurs in the context of visual object i (e.g., i and j are depicted in a same image). In an embodiment, the objective of the GloVe (Global Vectors for Word Representation) model for training to obtain visual object vectors is as defined below, where w∈R^{d} are visual object vectors and d represents the number of the dimensions of a visual object vector.

$$J ( w ) = {\sum }_{i , j} f ( {X}_{i j} ) {( {w}_{i}^{T} {w}_{j} - log {X}_{i j} )}^{2}$$

The selected weighting function ƒ(Xᵢⱼ) is:

$$f ( {X}_{ij} ) = \{ \begin{matrix}{( {X}_{ij} / {X}_{max} )}^{α} & if {X}_{ij} < {X}_{max} \\ 1 & otherwise\end{matrix}$$

Train the GloVe model until it converges with a gallery, and the resulting visual object vectors has the following nature: If the frequency of two visual objects i and j appeared together in images is very high, then the cosine value between visual object vectors wᵢ and wⱼ is close to 1. Therefore, for two or more single visual objects in an image, that are adjacent to each other in pixels, if the cosine value between any two of their corresponding visual object vectors exceeds a preset threshold (e.g., 0.95), then the method can include combining them as an identified compound visual object.

In this way, the processing at 202 and 204 can model an image as a mixture of subjects (also known as topics) where each subject is a probability distribution over visual objects, for example, as in BoW model.

At 206, at least one processor can augment the unsupervised machine learning classification model to incorporate spatial relationship of visual objects in an image, for example, to model the image as a mixture of subjects, where each subject is represented through placements of the visual objects in a mixture of concentric spheres centering on a mixture of intersections on a mixture of image layers, for example, horizontal layers. In this processing, spatial relationship is used as a feature of an image, having an influence on understanding the semantics and subject of an image. Understanding the spatial layout of objects allows for identifying or understanding the subject expressed in an image. FIGS. 5A and 5B illustrate examples of spatial relationships in visual objects in images. For example, if two people are far apart in an image, the subject of such an image may be about pedestrians 502; If they are very close to each other, the subject is more likely to about a couple 504.

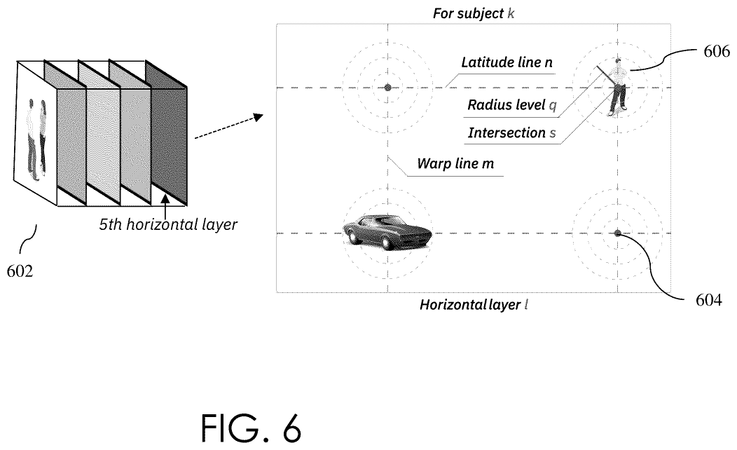

In an embodiment, one or more processors can regard an image as a three-dimensional container (like a box) for visual objects. FIG. 6 shows an example of such three-dimensional container in an embodiment. A three-dimensional container for visual objects can include:
L horizontal layers (e.g., 602). The distance between any two adjacent layers is equal to max_image_depth/L, where depth is represented by gray value of the image.
S intersections (e.g., 604) formed by M warp lines and N latitude lines on each layer.
Each intersection has Q concentric spheres with different radius levels (ranging from 1 to Q; the first radius level corresponds to a preset length e.g., 5-pixel width), centering on that same intersection (as sphere center).

In an embodiment, L, S, M, N, and Q can be given or preconfigured. The horizontal layers can be defined based on gray values of the pixels of the image. For example, each layer of L layers can represent a range of pixel values, e.g., gray values, in an image. For instance, consider that an image has 100 different pixel values (e.g., gray values). If there are 2 layers (e.g., L=2), each layer may represent pixel values of 100/2=50; e.g., layer 1 can includes pixels of the image that have values ranging from 0-49; layer 2 can have pixels of the image that have values ranging from 50-100.

At least one processor can augment LDA to model an image as a mixture of subjects, where each subject can further be represented through the placements of visual objects in a mixture of concentric spheres centering on a mixture of intersections on a mixture of horizontal layers.

Each single or compound visual object in an image can be mapped into a corresponding sphere based on its geometric center, average gray value and size in that image (the size of a visual object is exactly fit into a sphere), and is assigned a subject-layer-intersection-sphere label. For example: the assigned label of the object 606 (person in this example image) in the image is {k, l, s, q}, using radius levels to differentiate spheres. For each combination of subject, layer, intersection, and sphere (e.g. {k, l, s, q}), the augmented model generates a probability distribution over single and compound visual objects.

At 208, at least one processor can learn latent relationships between the placements of the visual objects in a three-dimensional space depicted in the image and image semantics. Such learning can train the unsupervised machine learning classification model to perform image subject classification through the placements of the visual objects in an image, for example, a new image. As described below in more detail also, Gibbs Sampling can be extended, in an embodiment, for the augmented subject classification model.

For example, in an embodiment, a generative process can be implemented. Formally, assume that a gallery contains G images g_{1 . . . G}, where each image is considered as a visual object's vector [symbol] _{g} of size N_{g}; each visual object o_{gn} in an image belongs to the visual object vocabulary of distinct single or compound visual objects of size V.

Let K be the total number of subjects, L be the total number of layers, S be the total number of intersections on a layer, and Q be the total number of concentric spheres centering on an intersection (that is, total Q radius levels). Let θ_{g} denote the probabilities (proportions) of K subjects in an image g; ψ_{gk} be the probabilities (proportions) of L layers under a subject k in the image g (the number of layers L is the same for all subjects); φ_{gkl} be the probabilities (proportions) of S intersections on a layer l under the subject k in the image g (the number of intersections S is the same for all layers); μ_{gkls} be the probabilities (proportions) of Q concentric spheres centering on an intersection s on the layer l under the subject k in the image g (the number of spheres Q is the same for all intersections); and ϕ_{klsq} be the multinomial probability distribution over visual objects associated with a subject k, a layer l, an intersection s and a sphere q.

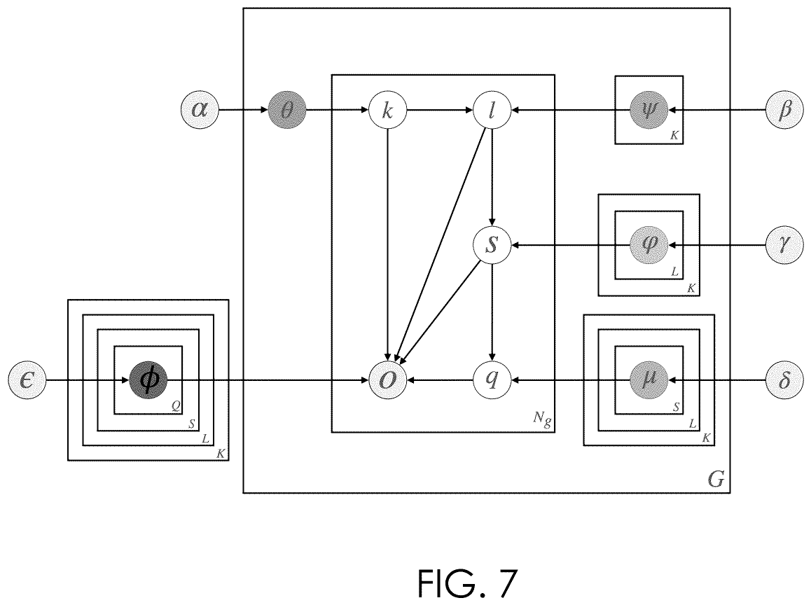

FIG. 7 illustrates a generative process in an embodiment. In an embodiment, the generative process can include the following:

for each sphere q centering on intersection s on layer l under subject k, draw a multinomial probability distribution over the visual object vocabulary V: ϕ_{klsq}˜Dir(ε);
for each image g,
draw a subject mixture θ_{g}˜Dir(α)
for each subject k, draw a layer mixture ω_{gk}˜Dir(β)
for each layer l under the subject k, draw an intersection mixture φ_{gkl}˜Dir(γ)
for each intersection s on the layer l under the subject k, draw a sphere mixture μ_{gkls}˜Dir(δ)
for each visual object o_{gn}, sample a subject assignment k_{gn}˜Mult(θ_{g}); sample a layer assignment l_{gn}˜Mult (ψ_{gk}_{_{gn}}); sample an intersection assignment s_{gn}˜Mult(φ_{gk}_{_{gn}}ₗ_{_{gn}}); sample a sphere assignment q_{gn}˜Mult (μ_{gk}_{_{gn}}ₗ_{_{gn}}ₛ_{_{gn}}); and sample a visual object o_{gn}˜Mult(φₖ_{_{gn}}ₗ_{_{gn}}ₛ_{_{gn}}_{q}_{_{gn}}).
   Repeat this process until the image g contains total N_{g} visual objects; do the same to every image in a gallery.

In the above algorithm (also shown in FIG. 7), α, β, γ, δ and ε are fixed symmetric Dirichlet's parameters. They can be interpreted as the prior counts of: visual objects assigned to a subject k in an image (e.g., (2,2,2)); visual objects assigned to layer l under subject k in an image; visual objects assigned to intersection s on layer l under subject k in an image; visual objects assigned to sphere q centering on intersection s on layer l under subject k in an image; a particular visual object o assigned to sphere q centering on intersection s on layer l under subject k within a gallery, respectively.

The following illustrates training an augmented LDA model and inferencing using the trained augmented LDA model in an embodiment.

To train the augmented (LDA) model, e.g., which learns the hidden parameters ϕ, ψ, φ, μ and θ, the method in an embodiment can use the collapsed Gibbs sampling, a Markov Chain Monte Carlo algorithm. The collapsed Gibbs sampler integrates out all parameters ϕ, ψ, φ, μ and θ in the joint distribution of the augmented model and converges to a stationary posterior distribution over all subjects' assignments [symbol] , layers' assignments [symbol] , intersections' assignments [symbol] , spheres' assignments [symbol] in a gallery. It iterates on each current observed visual object oᵢ and samples each corresponding qᵢ, sᵢ, lᵢ and kᵢ given all the previous sampled assignments in the augmented model [symbol] _{¬i}, [symbol] _{¬i}, [symbol] _{¬i}, and [symbol] _{¬i} and observed [symbol] _{¬i}, where [symbol] ={qᵢ, [symbol] _{¬i}}, [symbol] ={sᵢ, [symbol] _{¬i}}, [symbol] ={lᵢ, [symbol] _{¬i}}, [symbol] ={kᵢ, [symbol] _{¬i}} and [symbol] ={oᵢ, [symbol] _{¬i}}. In an embodiment, the derived sampling equation for training the augmented model can be:

$$p ( {k}_{i} = 𝕜 , {l}_{i} = 𝕝 , {s}_{i} = 𝕤 , {q}_{i} = 𝕢 \vert {\vec{k}}_{¬ i} , {\vec{l}}_{¬ i} , {\vec{s}}_{¬ i} , {\vec{q}}_{¬ i} , {o}_{i} = t , {\vec{o}}_{¬ i} )$$

$$∝ \frac{{n}_{𝕜𝕝𝕤𝕢 , ¬ i}^{( t )} + ε}{{\sum }_{t = 1}^{V} {n}_{𝕜𝕝𝕤𝕢 , ¬ i}^{( t )} + V ε} \cdot \frac{{n}_{g 𝕜𝕝𝕤 , ¬ i}^{( 𝕢 )} + δ}{{\sum }_{𝕢 = 1}^{Q} {n}_{g 𝕜𝕝𝕤 , ¬ i}^{( 𝕢 )} + Q δ} \cdot \frac{{n}_{g 𝕜𝕝 , ¬ i}^{( 𝕤 )} + γ}{{\sum }_{𝕤 = 1}^{S} {n}_{g 𝕜𝕝 , ¬ i}^{( 𝕤 )} + S γ} \cdot \frac{{n}_{g 𝕜 , ¬ i}^{( 𝕝 )} + β}{{\sum }_{𝕝 = 1}^{L} {n}_{g 𝕜 , ¬ i}^{( 𝕝 )} + L β} \cdot {n}_{g , ¬ i}^{( 𝕜 )} + α$$

Where [symbol] is the number of times visual object t being placed in sphere [symbol] centering on intersection [symbol] on layer [symbol] was assigned to subject [symbol] in a gallery; [symbol] is the number of times visual objects being placed in sphere [symbol] centering on intersection [symbol] on layer [symbol] under subject [symbol] was observed in image g; [symbol] is the number of times visual objects being placed at intersection [symbol] on layer [symbol] under subject [symbol] was observed in image g; [symbol] is the number of times visual objects being placed on layer [symbol] under subject [symbol] was observed in image g; [symbol] is the number of times subject [symbol] was observed in image g. All these counts can be computed excluding the current visual object oᵢ, which is indicated by the symbol [symbol] i. After the convergence of the Gibbs algorithm, the parameters ϕ, ψ, φ, μ and θ are estimated using the last obtained sample.

To infer new images, the following can be performed in an embodiment. For example, for each visual object in a new image, based on the layer, intersection and sphere of it, its related subject probability distribution can be obtained from the parameter ϕ_{klsq} (being considered stable and constant after model training). The maximum probability in a subject probability distribution indicates the subject of a visual object. Therefore, a new image's subject can further be estimated using the identified subjects of all included visual objects accordingly. Hence, in an embodiment, image subject classification can be performed through the placements of the visual objects in the image.

For example, in an embodiment, the learned or trained augmented LDA model can be used to infer or identify a subject of a given image. In an embodiment, a gallery of images (e.g., a collection of images) can be classified, for example, subjects of the images can be identified. Such classification can facilitate organization of the gallery of images, facilitate searches among the gallery of images. For example, referring back to FIG. 2, at 210, using trained unsupervised machine learning classification model, e.g., the trained augmented LDA model, at least one processor can perform image subject classification of a given image. One or more automated search engines, for example, can use image subject classification, to find or search for desired images.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

What is claimed is:

1. A computer-implemented method comprising:
replacing visual words of an unsupervised machine learning classification model with visual objects of an image;
combining at least two co-occurring single visual objects adjacent to each other, based on threshold adjacency, in pixels of the image to obtain a compound visual object;
augmenting the unsupervised machine learning classification model to model the image as a mixture of subjects, where each subject is represented through placements of the visual objects in a mixture of concentric spheres centering on a mixture of intersections on a mixture of horizontal layers; and
learning latent relationships between the placements of the visual objects in a three-dimensional space depicted in the image and image semantics,
wherein the learning trains the unsupervised machine learning classification model to perform image subject classification through the placements of the visual objects in a new image.

2. The computer-implemented method of claim 1, wherein the unsupervised machine learning classification model includes a Latent Dirichlet Allocation model.

3. The computer-implemented method of claim 1, further including extending Gibbs sampling equation for unsupervised machine learning classification model.

4. The computer-implemented method of claim 1, wherein the horizontal layers are defined based on gray values of the pixels of the image.

5. The computer-implemented method of claim 1, wherein the visual objects of the image are determined using panoptic segmentation.

6. The computer-implemented method of claim 1, wherein the visual objects of the image are determined using instance segmentation.

7. The computer-implemented method of claim 1, further including using the unsupervised machine learning classification model that is trained, to perform the subject image classification on a given new image.

8. A computer program product comprising a computer readable storage medium having program instructions embodied therewith, the program instructions readable by a device to cause the device to:
replace visual words of an unsupervised machine learning classification model with visual objects of an image;
combine at least two co-occurring single visual objects adjacent to each other, based on threshold adjacency, in pixels of the image to obtain a compound visual object;
augment the unsupervised machine learning classification model to model the image as a mixture of subjects, where each subject is represented through placements of the visual objects in a mixture of concentric spheres centering on a mixture of intersections on a mixture of horizontal layers; and
learn latent relationships between the placements of the visual objects in a three-dimensional space depicted in the image and image semantics,
wherein learning the latent relationships trains the unsupervised machine learning classification model to perform image subject classification through the placements of the visual objects in a new image.

9. The computer program product of claim 8, wherein the unsupervised machine learning classification model includes a Latent Dirichlet Allocation model.

10. The computer program product of claim 8, wherein the device is caused to extend Gibbs sampling equation for unsupervised machine learning classification model.

11. The computer program product of claim 8, wherein the horizontal layers are defined based on gray values of the pixels of the image.

12. The computer program product of claim 8, wherein the visual objects of the image are determined using panoptic segmentation.

13. The computer program product of claim 8, wherein the visual objects of the image are determined using instance segmentation.

14. The computer program product of claim 8, wherein the device is further caused to use the unsupervised machine learning classification model that is trained, to perform the subject image classification on a given new image.

15. A system comprising:
at least one processor;
a memory device coupled with the at least one processor;
the at least one processor configured at least to:
replace visual words of an unsupervised machine learning classification model with visual objects of an image;
combine at least two co-occurring single visual objects adjacent to each other, based on threshold adjacency, in pixels of the image to obtain a compound visual object;
augment the unsupervised machine learning classification model to model the image as a mixture of subjects, where each subject is represented through placements of the visual objects in a mixture of concentric spheres centering on a mixture of intersections on a mixture of horizontal layers; and
learn latent relationships between the placements of the visual objects in a three-dimensional space depicted in the image and image semantics,
wherein learning the latent relationships trains the unsupervised machine learning classification model to perform image subject classification through the placements of the visual objects in a new image.

16. The system of claim 15, wherein the unsupervised machine learning classification model includes a Latent Dirichlet Allocation model.

17. The system of claim 15, wherein the at least one processor is configured to extend Gibbs sampling equation for unsupervised machine learning classification model.

18. The system of claim 15, wherein the horizontal layers are defined based on gray values of the pixels of the image.

19. The system of claim 15, wherein the visual objects of the image are determined using panoptic segmentation.

20. The system of claim 15, wherein the visual objects of the image are determined using instance segmentation.
